(19) United States
(12) Patent Application Publication
(10) Pub. No.: US 2022/0000018 A1
(43) Pub. Date: Jan. 6, 2022

(54) Marking of Features for a Robotic Lawnmower

(71) Applicant: Husqvarna AB, Huskvarna (SE)

(72) Inventor: Petrus Ekbladh, Jonkoping (SE)

(21) Appl. No.: 17/368,359

(22) Filed: Jul. 6, 2021

(30) Foreign Application Priority Data
Jul. 6, 2020 (SE) 2050847-9

(51) Int. Cl. A01D 34/00; G05D 1/02

(52) U.S. Cl. CPC A01D 34/008; A01D 2101/00; G05D 1/0265

(57) ABSTRACT

A robotic lawnmower system (200) comprising a robotic lawnmower (100) comprising a grass cutting device (160), the robotic lawnmower (100) being arranged to enter a feature marking mode (1010) indicating a feature to be marked; find the feature (1020); adjust a cutting height (h1, h2) of the grass cutting device (160) to generate a mowing pattern (MP) marking the feature.

### TECHNICAL FIELD

This application relates to robotic lawnmowers and in particular to a system and a method for providing an improved marking of features for a robotic lawnmower.

### BACKGROUND

Automated or robotic lawnmowers are becoming increasingly more popular. In a typical deployment work area, such as a garden, the work area is enclosed by a boundary wire with the purpose of keeping the robotic lawnmower inside the work area.

An electric control signal may be transmitted through the boundary wire thereby generating an (electro-) magnetic field emanating from the boundary wire. The robotic lawnmower is typically arranged with one or more (electro-) magnetic sensors adapted to sense the control signal.

The robotic lawnmower system may also be arranged with one or more guide wires for guiding the robotic lawnmower to specific areas, such as the charging station or a hard-to-reach area.

Such wires are most typically arranged in a garden by being submerged in the lawn or dirt. They are thus difficult to see, and a user may forget or simply not know about where the wire in questions is. This is especially true if only one person in a household oversaw the installation of the robotic lawnmower system, where the other persons in the household may not know where the wires are placed.

This presents a problem when performing garden work, or other types of work in the garden where a wire may be cut accidentally. Finding which wire and where the wire has been cut can be a very time-consuming task that even some users may not know how to perform, whereby an expensive technician may have to be called in.

Thus, there is a need for an improved manner of enabling a manner for performing work in a garden or other work area without risking to accidentally cut any wires.

### SUMMARY

As will be disclosed in detail in the detailed description, the inventors have realized a simple and elegant manner of enabling the robotic lawnmower to mark features, such as the wires, by adjusting the cutting height temporarily in locations where the feature is found. This provides an easy-to-see marking of the feature as the grass will be cut differently in the area of the feature. Furthermore, it is a temporary marking that will go away by itself after a few days or after the next (few) operation(s) as the grass will grow out and again be cut at the same height, whereby the markings will be gone.

It is therefore an object of the teachings of this application to overcome or at least reduce those problems by providing a robotic lawnmower system comprising a robotic lawnmower comprising one or more grass cutting devices, the robotic lawnmower being arranged to enter a feature marking mode indicating a feature to be marked; find the feature; adjust a cutting height (h1, h2) of at least one of the one or more grass cutting devices to generate a mowing pattern marking the feature.

It is also an object of the teachings of this application to overcome the problems by providing a method for use in a robotic lawnmower system comprising a robotic lawnmower comprising one or more grass cutting devices, the method comprising: entering a feature marking mode indicating a feature to be marked; finding the feature; adjusting a cutting height (h1, h2) of at least one of the one or more grass cutting devices to generate a mowing pattern marking the feature.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIG. 1A shows an example of a robotic lawnmower according to one embodiment of the teachings herein;

FIG. 1B shows a schematic view of the components of an example of a robotic lawnmower being a robotic lawnmower according to an example embodiment of the teachings herein;

FIG. 2 shows an example of a robotic lawnmower system according to an example embodiment of the teachings herein;

FIG. 3 shows a schematic view of a robotic lawnmower, such as in FIGS. 1A and 1B, where the cutting height is adjusted according to an example embodiment of the teachings herein;

FIG. 4 shows a schematic view of a mowing pattern according to an example embodiment of the teachings herein;

FIG. 5A shows an example of the robotic lawnmower system of FIG. 2 wherein a guide wire has been marked according to an example embodiment of the teachings herein;

FIG. 5B shows an example of the robotic lawnmower system of FIG. 2 wherein a guide wire has been marked according to an alternative or additional example embodiment of the teachings herein;

FIG. 6 shows an example of the robotic lawnmower system of FIG. 2 wherein a guide wire and a boundary wire have been marked according to an alternative or additional example embodiment of the teachings herein;

FIG. 7 shows an example of the robotic lawnmower system of FIG. 2 wherein an area with bad satellite reception has been marked according to an alternative or additional example embodiment of the teachings herein;

FIG. 8A shows an example of the robotic lawnmower system of FIG. 2 wherein features, such as a power line and a water mains, are present in the work area according to an alternative or additional example embodiment of the teachings herein;

FIG. 8B shows an example of the robotic lawnmower system of FIG. 2 and FIG. 8A wherein the features have been marked according to an alternative or additional example embodiment of the teachings herein;

FIG. 9 shows an example of the robotic lawnmower system of FIG. 2 wherein an area with significant interference has been marked according to an alternative or additional example embodiment of the teachings herein;

FIG. 10 shows a corresponding flowchart for a method according to an example embodiment of the teachings herein; and

FIG. 11 shows a schematic view of a user interface according to one example embodiment of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein. Like reference numbers refer to like elements throughout.

It should be noted that even though the description given herein will be focused on robotic lawnmowers, the teachings herein may also be applied to, robotic ball collectors, robotic mine sweepers, robotic farming equipment, or other robotic lawnmowers where lift detection is used and where the robotic lawnmower is susceptible to dust, dirt or other debris.

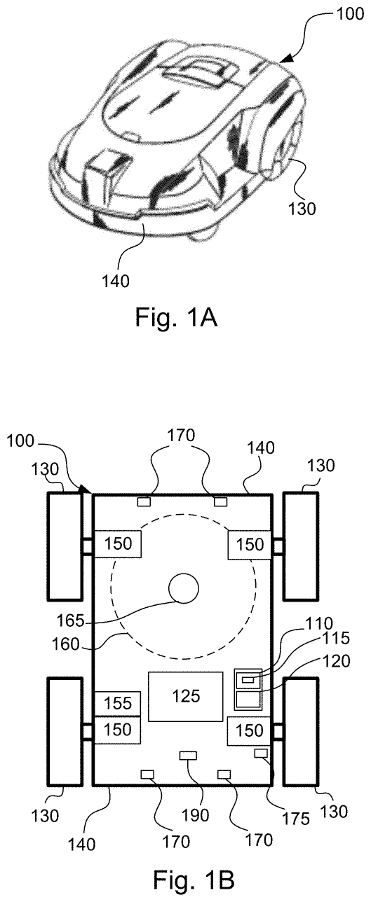

FIG. 1A shows a perspective view of a robotic lawnmower 100, having a body 140 and a plurality of wheels 130 (only one side is shown). The rwt 100 may be a multi-chassis type or a mono-chassis type (as in FIG. 1A). A multi-chassis type comprises more than one main body parts that are movable with respect to one another. A mono-chassis type comprises only one main body part.

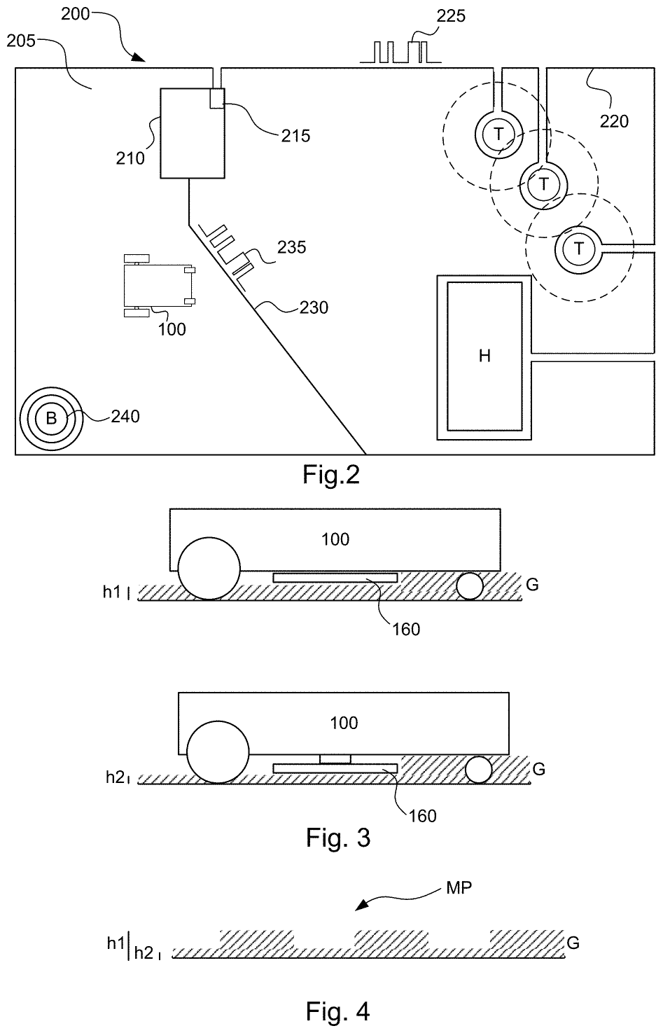

The robotic lawnmower 100 may comprise charging skids for contacting contact plates (not shown in FIG. 1) when docking into a charging station (not shown in FIG. 1, but referenced 210 in FIG. 2) for receiving a charging current through, and possibly also for transferring information by means of electrical communication between the charging station and the robotic lawnmower 100.

FIG. 1B shows a schematic overview of the robotic lawnmower 100. In this example embodiment the robotic lawnmower 100 is of a mono-chassis type, having a main body part 140. The main body part 140 substantially houses all components of the robotic lawnmower 100. The robotic lawnmower 100 has a plurality of wheels 130. In the exemplary embodiment of FIG. 1B the robotic lawnmower 100 has four wheels 130, two front wheels and two rear wheels. At least some of the wheels 130 are drivably connected to at least one electric motor 150. It should be noted that even if the description herein is focused on electric motors, combustion engines may alternatively be used, possibly in combination with an electric motor.

The robotic lawnmower 100 also comprises one or more grass cutting devices 160. A grass cutting device 160 may comprise a rotating blade 160 driven by a cutter motor 165. The height of at least one of the one or more grass cutting device 160 is adjustable, as will be discussed below with referenced to FIG. 3.

The robotic lawnmower 100 also has (at least) one battery 155 for providing power to the motor(s) 150 and/or the cutter motor 165.

The robotic lawnmower 100 also comprises a controller 110 and a computer readable storage medium or memory 120. The controller 110 may be implemented using instructions that enable hardware functionality, for example, by using executable computer program instructions in a general-purpose or special-purpose processor that may be stored on the memory 120 to be executed by such a processor. The controller 110 is configured to read instructions from the memory 120 and execute these instructions to control the operation of the robotic lawnmower 100 including, but not being limited to, the propulsion of the robotic lawnmower. The controller 110 may be implemented using any suitable, available processor or Programmable Logic Circuit (PLC). The memory 120 may be implemented using any commonly known technology for computer-readable memories such as ROM, RAM, SRAM, DRAM, FLASH, DDR, SDRAM or some other memory technology.

The robotic lawnmower 100 may further be arranged with a wireless communication interface 115 for communicating with other devices, such as a server, a personal computer or smartphone, the charging station, and/or other rwts. Examples of such wireless communication devices are Bluetooth®, WiFi® (IEEE802.11b), Global System Mobile (GSM) and LTE (Long Term Evolution), to name a few.

The robotic lawnmower 100 is also arranged with a user interface 125 for receiving user commands and/or instructions through. The user interface 125 may comprise one or more physical buttons and a display. Alternatively or additionally the user interface 125 may comprise a touch screen arranged to present virtual buttons. Alternatively or additionally the user interface 125 is remote to the robotic lawnmower 100, for example part of a user device (such as a smartphone, a tablet computer or other computer), wherein the commands received through the user interface 125 are forwarded to the robotic lawnmower 100 via the communications interface 115.

For enabling the robotic lawnmower 100 to navigate with reference to a boundary wire emitting a magnetic field caused by a control signal transmitted through the boundary wire, the robotic lawnmower 100 is further configured to have at least one magnetic field sensor 170 arranged to detect the magnetic field (not shown) and for detecting the boundary wire and/or other navigation wires. The sensors 170 may also be used for receiving (and possibly also sending) information to/from a signal generator (will be discussed with reference to FIG. 2). In some embodiments, the sensors 170 may be connected to the controller 110, possibly via filters and an amplifier, and the controller 110 may be configured to process and evaluate any signals received from the sensors 170. The sensor signals are caused by the magnetic field being generated by the control signal being transmitted through the boundary wire. This enables the controller 110 to determine whether the robotic lawnmower 100 is close to or crossing the boundary wire, or inside or outside an area enclosed by the boundary wire. It also allows the robotic lawnmower 100 to follow a wire, for example by navigating so that one magnetic field sensor is on one side of the wire and the other magnetic field sensor is on the other side of the wire. Alternatively, the robotic lawnmower 100 may be arranged to follow a wire by following a set signal strength level of the received signal from the magnetic field sensor 170. Such manners of following a wire are known in the art and need no further details.

The robotic lawnmower 100 may further comprise one or more sensors for deduced navigation 175. Examples of sensors for deduced reckoning are odometers, accelerometers, gyroscopes, and compasses to mention a few examples.

In one embodiment, the robotic lawnmower 100 may further comprise at least one navigation sensor, such as a beacon navigation sensor and/or a satellite navigation sensor 190. The beacon navigation sensor may be a Radio Frequency receiver, such as an Ultra Wide Band (UWB) receiver or sensor, configured to receive signals from a beacon, such as a Radio Frequency beacon (referenced 240 in FIG. 2), for example a UWB beacon. Alternatively or additionally, the beacon navigation sensor may be an optical receiver configured to receive signals from an optical beacon. The satellite navigation sensor may be a GPS (Global Positioning System) device or other Global Navigation Satellite System (GNSS) device. The navigation sensor 190 may also be a combination of a beacon sensor and a satellite navigation sensor, such as in a Real-Time Kinetic (RTK) navigation system.

The use of such a navigation sensor 190 enables the robotic lawnmower 100 to navigate the work area according to a map stored in the memory 120, or possibly received through the communications interface 115.

In embodiments, where the robotic lawnmower 100 is arranged with a navigation sensor, the magnetic sensors 170 are optional.

FIG. 2 shows a schematic view of a robotic lawnmower system 200 in one embodiment. The schematic view is not to scale. The robotic lawnmower system 200 comprises a robotic lawnmower 100 adapted to operate within a work area.

The robotic lawnmower system 200 may also comprise a charging station 210 which in some embodiments is arranged with a signal generator 215 and a boundary wire 220. The signal generator is arranged to generate a control signal 225 to be transmitted through the boundary wire 220. In some embodiments, the robotic lawnmower system 200 also comprises one or more guide wires 230 and the signal generator is arranged to generate a (different) control signal 235 to be transmitted through the guide wire 230. By utilizing different control signals for different wires, the robotic lawnmower 100 may differentiate between the wires and adapt its operation and/or navigation accordingly. The control signal(s) generates and emits a magnetic field when being transmitted through the boundary wire (or other wire) that may be detectable by the magnetic field sensors 170 of the robotic lawnmower 100.

The boundary wire 220 is arranged to enclose a work area 205, in which the robotic lawnmower 100 is supposed to serve.

The robotic lawnmower system 200 may also optionally comprise at least one beacon 240 to enable the robotic lawnmower to navigate the work area using the beacon navigation sensor(s) 190.

The work area 205 is in this application exemplified as a garden, but can also be other work areas as would be understood. The garden contains a number of obstacles (O), exemplified herein by a number (3) of trees (T) and a house structure (H). The trees are marked both with respect to their trunks (filled lines) and the extension of their foliage (dashed lines).

FIG. 3 shows a schematic view of a robotic lawnmower 100 such as in FIGS. 1A and 1B. The schematic view of FIG. 3 is a sideways view where the height of the grass cutting device 160 over the ground is shown. In the upper portion of FIG. 3 it is illustrated how the grass G is cut at a first height h1. In the lower portion of FIG. 3 it is illustrated how the grass G is cut at a second height h2. As can be seen, the first height h1 is not the same as the second height h2. In this example the first height h1 is higher than the second height h2, but it could equally be the opposite case. FIG. 3 illustrates how a robotic lawnmower 100 according to the teachings herein is able to adjust the cutting height, possibly by raising or lowering the grass cutting device 160.

FIG. 4 shows a schematic view of an example of a resulting mowing pattern MP that is caused by the grass cutting device of a robotic lawnmower according to herein being caused to cut the grass at different heights, in this example intermittently at a first height h1 and intermittently at a second height h2.

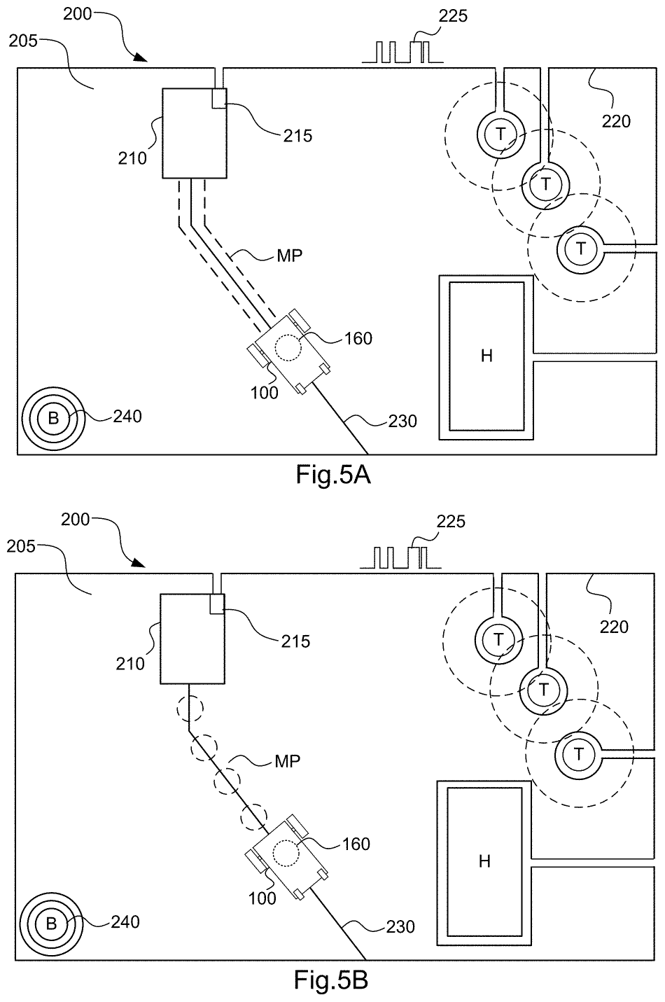

As is discussed in the summary above, the inventors have realized that by adjusting the cutting height a temporary marking of a feature may be achieved in a very simple and elegant way. This will now be discussed in greater detail with simultaneous reference to FIGS. 5A, 5B, 6, 7, 8A, 8B and 9 and to FIG. 10. Either of FIGS. 5A, 5B, 6, 7, 8A, 8B and 9 show a schematic view of a robotic lawnmower system 200 implementing one aspect of the teachings herein. FIG. 10 shows a flowchart of a general method according to the teachings herein.

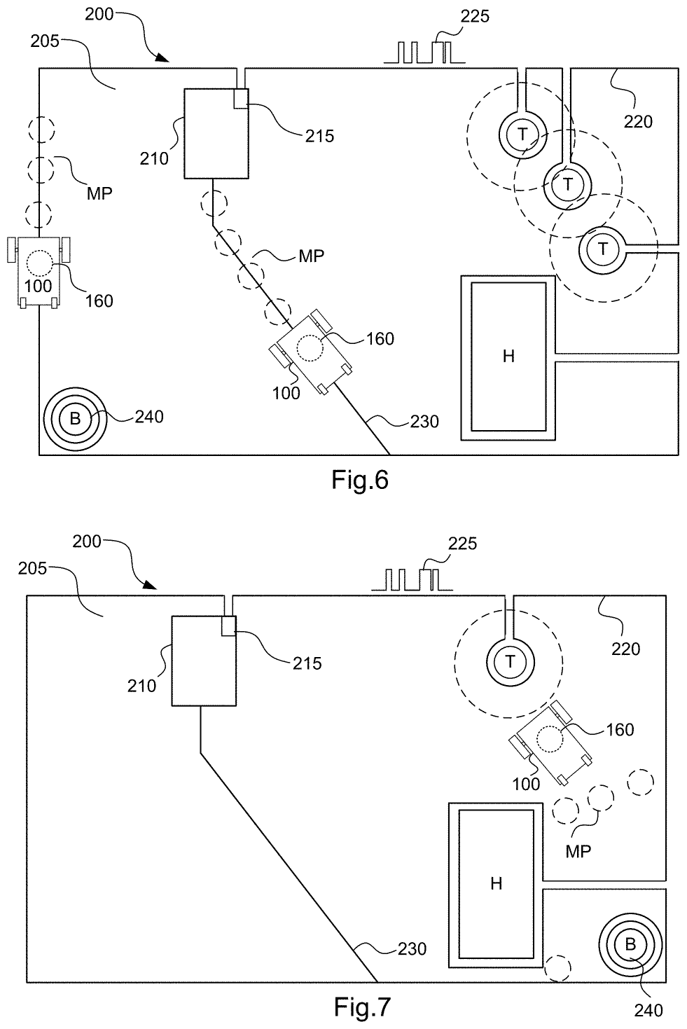

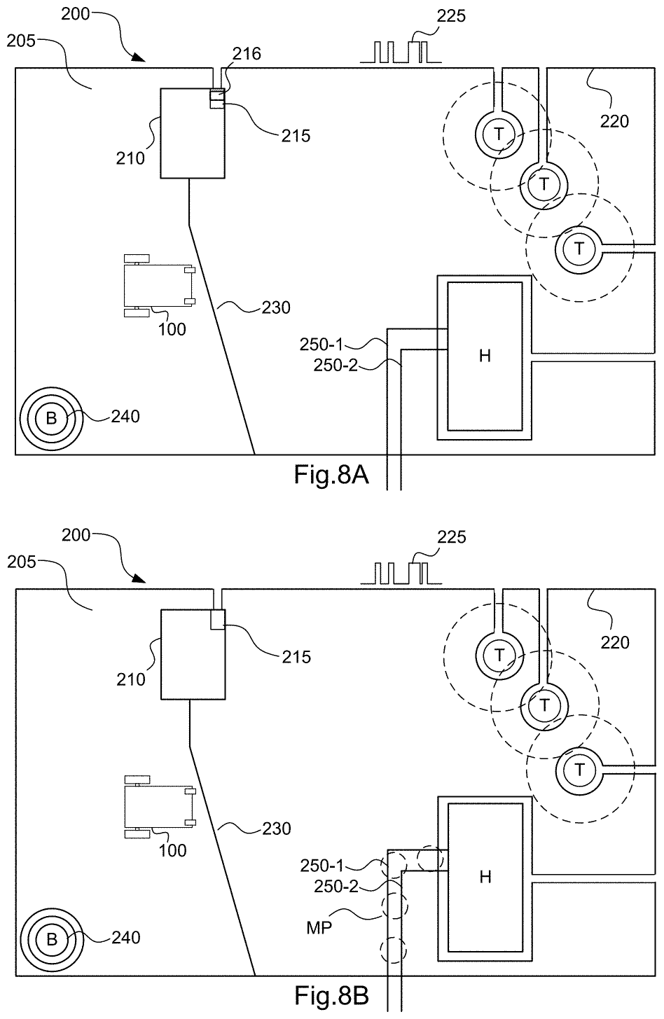

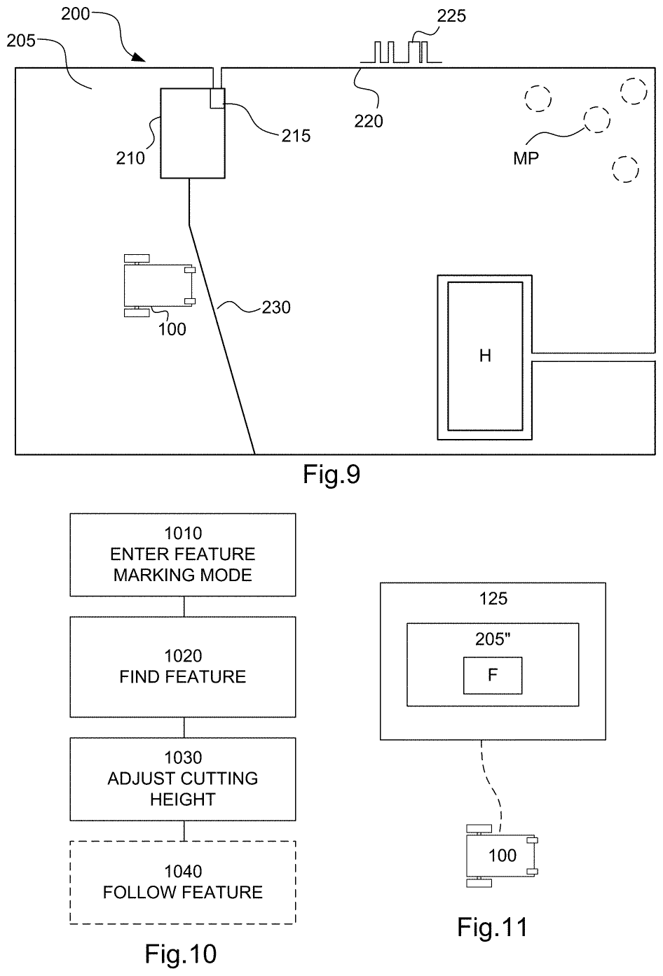

To instruct the robotic lawnmower 100 to mark a feature, a feature marking mode may be initiated by a user, for example through the user interface 125. Alternatively or additionally, the feature marking mode may be initiated as a scheduled operation by the controller 110. In all circumstances, the controller will receive an indication to enter the 1010 feature marking mode and do so. There may be several commands available to a user for selecting which feature is to be found. For example, there may be an option to mark the feature the guide wire 230 (as will be discussed with reference to FIG. 5A and FIG. 5B). Alternatively or additionally there may be an option to mark the feature the boundary wire 220 (as will be discussed with reference to FIG. 6). Alternatively or additionally there may be an option to mark a feature being an area where satellite signal reception is low or failing (as will be discussed with reference to FIG. 7). Alternatively or additionally there may be an option to mark one or more structural features 250, such as power lines and/or water mains (as will be discussed with reference to FIG. 8A and FIG. 8B). Alternatively or additionally there may be an option to mark a feature being an area where significant interference is detected (as will be discussed with reference to FIG. 9). Alternatively or additionally there may be an option for the user to select to find a feature, and then to identify which feature(s) by selecting them on a graphical representation of a map of the work area, or from a list of available features.

It should be noted that for some features, the feature marking mode is part of the normal operation mode, or at least arranged to operate in parallel to the normal operating mode. This enables for providing updates on a condition and how it changes. For example, a user may be interested in how the situation with interference changes from one operation to another and thus instruct the robotic lawnmower 100 to mark areas where significant interference is detected regularly or in all operations.

As the feature marking mode is entered, the robotic lawnmower identifies which feature it is to find. An indication of which feature that is to be marked is received along with the command to enter the feature marking mode. In one embodiment, there may be several feature marking modes that may operate in parallel, thereby enabling the robotic lawnmower 100 to mark more than one type of feature. The robotic lawnmower 100 then proceeds to find 1020 or detect the feature. The manner of how the feature is found or detected varies with the type of feature which will be discussed in further detail below. As the feature has been detected or found, the robotic lawnmower adjusts 1030 the cutting height to mark the feature generating a mowing pattern. Optionally for some features, the robotic lawnmower 100 then proceeds by following 1040 the feature so that the mowing pattern marking the feature extends along or around the feature.

FIG. 5A shows a schematic view of the robotic lawnmower system 200 of FIG. 2, wherein the robotic lawnmower 100 has been arranged to mark a feature, in this example the guide wire 230, with a mowing pattern, in this example the feature is the guide wire 230. As can be seen a mowing pattern MP has been established by the robotic lawnmower adapting the cutting height and following the feature. As the robotic lawnmower 100 has adapted the cutting height to a height different from (higher or lower than) the height used in surrounding areas, the mowing pattern will be clearly visible, at least temporarily. In this example the robotic lawnmower is able to follow the guide wire as discussed above by straddling the guide wire generating a corridor mowing pattern that follows the guide wire 230 and is essentially the same width as the grass cutting device 160.

FIG. 5B shows a schematic view of the robotic lawnmower system 200 of FIG. 2, wherein the robotic lawnmower 100 has been arranged to mark the feature, the guide wire 230. Similarly to the example scenario of FIG. 5A, the robotic lawnmower 100 has marked the guide wire by adjusting the cutting height and followed the guide wire 230. However, in this example, the robotic lawnmower 100 has adjusted the cutting height repeatedly toggling between a higher or first cutting height (referenced h1 in FIG. 3) and a lower or second cutting height (referenced h2 in FIG. 3). In such an example, one of the cutting heights may be the cutting height of the surrounding area. The resulting mowing pattern will thus be a series of indentations (or raises) in the cut grass. The mowing pattern MP is thus dotted. To make the indentations (or “dots”) more clear, the robotic lawnmower 100 may be arranged to stop when adjusting the height, for example from the first height to the second height, cut the grass for a time period, adjust the height again (from the second height to the first height) and then continue its movement.

FIG. 6 shows a schematic view of the robotic lawnmower system 200 of FIG. 2, wherein the robotic lawnmower 100 has been arranged to mark the feature, in this example being the boundary wire 220. Similarly to the example scenario of FIG. 5B, the robotic lawnmower 100 has marked the boundary wire 220 by repeatedly adjusting the cutting height while following the boundary wire 220 generating a “dotted” mowing pattern. It should be noted that in FIG. 6, both the guide wire 230 and the boundary wire 220 are marked, but it should be understood that the boundary wire 220 may be marked irrespective whether a guide wire (or other feature) is marked.

The boundary wire 220 may also be marked where it is laid to form “islands” as it has been around for example the trees T in FIG. 2 and FIG. 5B.

Alternatively to the robotic lawnmower 100 following the wire to be marked, the robotic lawnmower 100 may be arranged to mark the feature each time the feature is detected. Over time, this will provide the same mowing pattern. Such marking may take longer time, but may be done in parallel with or simultaneous with normal operation, thereby saving time overall.

FIG. 7 shows a schematic view of the robotic lawnmower system 200 of FIG. 2, wherein the robotic lawnmower 100 has been arranged to mark a feature, being an area where satellite reception is low or failing. In this example, the area behind the house H has been marked.

To enable the robotic lawnmower 100 to mark such an area, the robotic lawnmower 100 is arranged to detect that a satellite reception signal received by the satellite navigation sensor (or other signal received by other sensor) has a signal strength that falls below a threshold value. Alternatively it may be determined that the received signal has a correlation that falls below a threshold confidence value. As this is detected, the robotic lawnmower 100 is arranged to adjust the cutting height and mark the location where this is detected. In one embodiment, the robotic lawnmower 100 may follow a path where it is detected that the signal received has the same or lower signal strength or correlation, whereby the border of the area is marked. In one embodiment, the robotic lawnmower 100 may simply mark the location and then resume operation, possibly utilizing an alternative navigation sensor, such as the deduced navigation sensor(s) 175. In such an embodiment the robotic lawnmower 100 is arranged to again mark a location where it is detected that the received signal exceeds the relevant threshold value again. Over time, this will provide a marking of the border of the area where signal reception is low. For the context of this application, a threshold value will be considered to be exceeded both when the relevant signal property fall below or raises above the corresponding threshold value. As in FIGS. 5A and 5B the marking may be done continuously or intermittently (“dotted”).

Marking such an area may be beneficial for a user as the user may not be aware of where a supplemental navigation beacon 240 should best be placed. In the example of FIG. 7, the beacon 240 has been moved to the area behind the house. As indicated above, not only satellite reception areas may be marked but any navigation signal area may be marked, for example an area where the beacon signal is received badly or with low confidence.

FIG. 8A shows a schematic view of the robotic lawnmower system 200 of FIG. 2, wherein the robotic lawnmower system 200—or rather the work area—also houses one or more structural features 250. In this example two structural feature, namely a power line 250-1 and a water mains 250-2 are present. As would be understood it is highly desired to not cause damage to such structural features when doing garden work or other work in the garden.

A user may thus instruct the robotic lawnmower 100 to—either during operation or in a specific operation—to enter a mode where such features are marked. The features are beneficially selected using a map of the work area 205. The location of the feature(s) being saved as part of or in addition to the map. In one embodiment, the structural features may not even be part of the map, but the user may be enabled to by providing user input through the user interface, drawn in the location of such feature(s). The location may be an area or a line or a single location depending on the type of structural (or other) feature to be marked.

The location of the feature(s) to be marked are then provided to the robotic lawnmower 100 as part of the robotic lawnmower entering the feature marking mode, and the robotic lawnmower 100 finds the feature by finding the location of the feature(s). As the location is found, the robotic lawnmower 100 adapts the cutting height and generates the mowing pattern MP.

As in other examples given herein, the feature marking may be executed as a specific operation (wherein the robotic lawnmower 100 follows the location of the feature(s)) or in parallel with normal operation (wherein the robotic lawnmower 100 marks the location of the feature(s) each time it is passed), or as a combination thereof, perhaps starting as a parallel operation but ending as a specific operation to ensure the feature is marked.

FIG. 8B shows a schematic view of the robotic lawnmower system 200 of FIG. 8A, wherein the structural features 250 have been marked with a dotted pattern.

It should be noted that this manner of marking features may be applied to any type of feature, the user wishes to mark. Possibly to mark an area where a shed is to be raised, marking an area where a flowerbed is to be planted, to give a few examples.

As discussed above, the boundary wire 220 may also be marked where it is laid to form “islands” as it has been around for example the trees T in FIG. 2 and FIG. 8A. Such islands and crossings out to the islands would or could be stored in the map, or otherwise indicated on the map by the user, and thus be marked as any other feature the user chooses to have the robotic lawnmower to mark.

FIG. 9 shows a schematic view of the robotic lawnmower system 200 of FIG. 2, wherein the robotic lawnmower 100 has been arranged to mark a feature, being an area where significant interference is present. In this example, the area in the upper hand right corner has been marked. To enable the robotic lawnmower 100 to mark such an area, the robotic lawnmower 100 is arranged to detect that interference is significant. This may be detected in that a signal-to-noise ratio of a received navigation signal (such as for example the control signal 225) exceeds a threshold value. Alternatively or additionally this may be detected in that a received navigation signal (such as for example the control signal 225) receives a correlation falling below a threshold value. As discussed in relation to FIG. 7, a threshold value will be considered to have been exceeded when a relevant parameter falls below or raises above the corresponding threshold value. As this is detected, the robotic lawnmower 100 is arranged to adjust the cutting height and mark the location where this is detected. Also as discussed in relation to FIG. 7, the robotic lawnmower 100 may be arranged to follow a path where the signal exceeds the corresponding threshold level, i.e. where it is detected that the interference is significant, or to only mark such location as it is detected and then continue operation.

Returning to the example of FIG. 8A and as discussed in the above with relation to entering a feature marking mode, FIG. 11 shows a schematic view of a user interface 125 (remote or internal to the robotic lawnmower 100) according to one embodiment of the teachings herein, the user interface 125 being arranged to present a graphical representation 205″ of the work area, wherein a user is able to select or otherwise indicate (as discussed in the above) a feature F to be marked. The location of the feature F is retrieved and provided to the robotic lawnmower (internally or through the communications interface 115 as indicated by the dashed line from the user interface 125 and the robotic lawnmower 100) as part of the command to enter the feature marking mode. As discussed above, the user interface 125 may be internal to the robotic lawnmower 100 or it may be external and part of a user device capable of providing a user interface, the user device being represented herein by the user interface 125.

Should the mowing pattern be considered to not be visible enough or if the mowing pattern need to be visible for a longer time period, the mowing pattern MP may be filled in by a user for example by spraying it to make it more visible. As discussed in relation to FIG. 1B, the robotic lawnmower 100 is arranged to perform a function by the controller 110 being configured to control the function in combination with any of the relevant components needed for performing the function. For example, for the robotic lawnmower 100 to be arranged to adjust the cutting height, the controller is configured to adapt the cutting height of the grass cutting device 160.

As has also been indicated above, the robotic lawnmower may be arranged to find and mark more than one feature, the feature marking modes thus not being exclusive to one another.

1. A robotic lawnmower system comprising a robotic lawnmower comprising one or more grass cutting devices, the robotic lawnmower being arranged to:
enter a feature marking mode indicating a feature to be marked;
find the feature;
adjust a cutting height of at least one of the one or more grass cutting devices to generate a mowing pattern marking the feature.

2. The robotic lawnmower system according to claim 1, wherein the feature marking mode is executed as a specific operation.

3. The robotic lawnmower system according to claim 1, wherein the feature marking mode is executed during regular operation of the robotic lawnmower.

4. The robotic lawnmower system according to claim 1 wherein the robotic lawnmower is arranged to enter the feature marking mode by receiving user input thereto through a user interference.

5. The robotic lawnmower system according to claim 4, wherein the user input indicates the feature to be marked.

6. The robotic lawnmower system according to claim 1, wherein the robotic lawnmower is arranged to mark the feature by following the feature after adjusting the cutting height.

7. The robotic lawnmower system according to claim 6, wherein the robotic lawnmower is arranged to mark the feature by adjusting the cutting height repeatedly.

8. The robotic lawnmower system according to claim 1, wherein the robotic lawnmower is arranged to mark the feature by adjusting the cutting height each time the feature is found.

9. The robotic lawnmower system according to claim 1, the robotic lawnmower system further comprising a guide wire, wherein the feature to be marked is the guide wire.

10. The robotic lawnmower system according to claim 1, wherein the feature to be marked is an area where signal reception exceeds a threshold value.

11. The robotic lawnmower system according to claim 1, wherein the feature to be marked is an area where interference exceeds a threshold value.

12. The robotic lawnmower system according to claim 1, wherein the feature to be marked is a feature indicted by a user on a graphical representation of the work area.

13. A method for use in a robotic lawnmower system comprising a robotic lawnmower comprising one or more grass cutting devices, the method comprising:
entering a feature marking mode indicating a feature to be marked;
finding the feature;
adjusting a cutting height of at least one of the one or more grass cutting devices to generate a mowing pattern the feature.
